(19) United States
(12) Patent Application Publication
(10) Pub. No.: US 2008/0092161 A1
(43) Pub. Date: Apr. 17, 2008

(54) Interactive television service system for providing personalized advertising message

(75) Inventor: Chien-Liang Chen, Taipei City (TW)

Correspondence Address: RABIN & Berdo, PC, 1101 14TH STREET, NW, SUITE 500, WASHINGTON, DC, 20005, US

(73) Assignee: Global Vision System Co., Ltd., Taipei City (TW)

(21) Appl. No.: 11/633,426

(22) Filed: Dec. 5, 2006

(30) Foreign Application Priority Data
Sep. 27, 2006 (TW) 095217293

(51) Int. Cl. H04N 7/10; G06F 13/00; H04N 7/025; G06F 3/00; H04N 5/445

(52) U.S. Cl. 725/35; 725/34; 725/46

(57) ABSTRACT

An interactive television service system for providing personalized advertising message is provided, which connects to at least one set-top box by a network. The system includes a back-end interactive television server and an advertising message management module. The back-end interactive television server connects to the set-top box through the network, to transmit one of the interactive video program lists and one of the interactive video service contents to the set-top box. The advertising message management module is connected to the back-end interactive television server to store, manage or send one or more advertising messages, so when the back-end interactive television server transmits the interactive video program list and interactive video service contents, the back-end interactive television server retrieves at least one of the related advertising messages from the advertising message management module to the set-top box.

### CROSS-REFERENCE TO RELATED APPLICATIONS

This non-provisional application claims priority under 35 U.S.C. § 119(a) on Patent Application No(s). 095217293 filed in Taiwan, R.O.C. on Sep. 27, 2006, the entire contents of which are hereby incorporated by reference.

### BACKGROUND

1. Field of the Invention

The invention relates to interactive television, and more particularly to an interactive television service system for providing personalized advertising message.

2. Related Art

Presently, the television advertisements are delivered at a pre-reserved time period among a television program, which is purchased by the advertisers to deliver his advertisement. Under this method of advertising, the advertisers choose the contents of advertisements to optimize the advertising effect by forecasting which viewer group is viewing the television program according to the time schedule that the television program is broadcasted.

However, the time schedule of a television program of an interactive television service is absent, which means the advertisers can not forecast which viewer group is viewing the television program according to the time schedule that the television program is broadcasted, such that the advertisers can not choose the best contents of advertisements to optimize the advertising effect according to the time schedule of the television program. Furthermore, although advertisement can be exhibited by a bar running among the interactive TV list or a pop-up window, a most adequate content of advertisement still can not be decided because the viewer group is difficult to be forecasted.

Moreover, although advertisement can be changed with the time to be broadcasted, like the traditional way, viewers who watch the interactive TV have different habit of watching TV, where everyone may have different time of watching TV. Therefore, advertising according to TV program schedule is getting more difficult to deliver advertisement to the right group. Hence, for interactive TV, another method for advertising to the right group needs to be developed.

### SUMMARY

In view of above, the object of the present invention is to provide an interactive television service system, which delivers advertisement according to the viewer group to optimize the advertising effect.

In order to achieve the object of the present invention, an interactive television service system for providing personalized advertising message of the present invention is provided, which connects to at least one set-top box through a network, i.e. the internet. The system includes a back-end interactive television server and an advertising message management module. The back-end interactive television server connects to the set-top box through the network to transmit one of a plurality of interactive video program lists and one of a plurality of the interactive video service contents to the set-top box.

The advertising message management module is connected to the back-end interactive television server. The advertising message management module is provided for storing a plurality of advertising messages, so when the back-end interactive television server transmits the interactive video program list and interactive video service contents, the back-end interactive television server also retrieves at least one of the advertising messages from the advertising message management module to the set-top box.

The present invention transmits advertising messages according to the personal data, preferences, or habit of watching TV of a viewer who watches the interactive television, so as to optimize the advertising effect.

### BRIEF DESCRIPTION OF THE DRAWINGS

The present invention will become more fully understood from the detailed description given below, which is for illustration only and thus is not limitative of the present invention, wherein:

FIG. 1 is a block diagram showing the application of an embodiment of the invention;

FIG. 2 is a block diagram showing the components of the embodiment of the present invention;

FIG. 3 is a block diagram showing the operation of the embodiment of the invention; and

FIG. 4 is block diagram showing the data in the member database of the embodiment.

### DETAILED DESCRIPTION

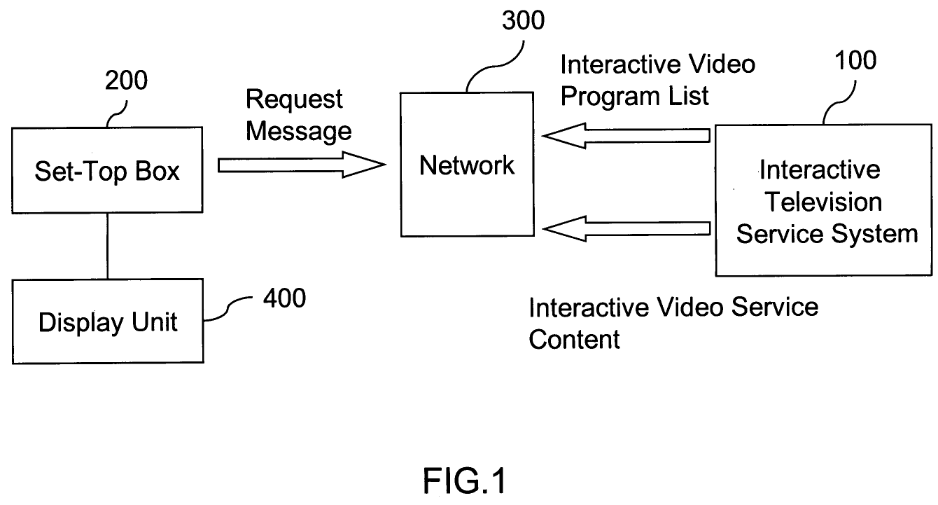

Referring to FIG. 1, an interactive television service system 100 of an embodiment of the present invention is provided, the interactive television service system 100 is provided for providing personalized advertising messages of an interactive television. The interactive television service system 100 connects to set-top boxes 200 through a network 300, i.e. the internet. According to a request message transmitted from one of the set-top boxes 200, the interactive television service system 100 transmit an interactive video program list and an interactive video service content to the set-top box 200, so that the set-top box 200 generates video signal to a display unit 400. The display unit 400 can be a television, a monitor of desktop computer and so on.

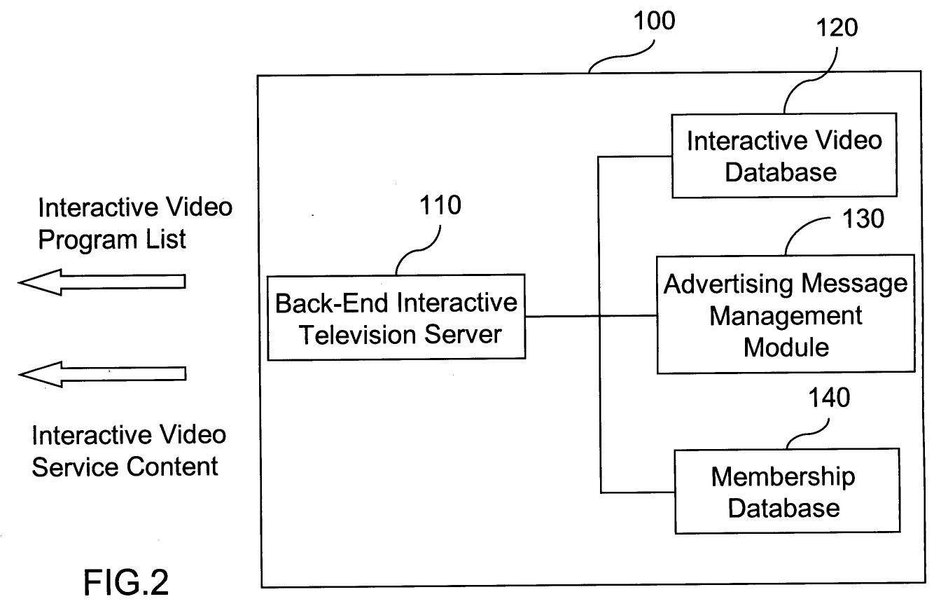

Referring to FIG. 2, the interactive television service system 100 includes a back-end interactive television server 110, an interactive video database 120, an advertising message management module 130, and a member database 140.

The back-end interactive television server 110 connects to the set-top boxes 200 through the network 300, wherein the back-end interactive television server 110 receives request messages from the set-top boxes 20, and then retrieves the corresponding data and transmits them to the set-top box 200.

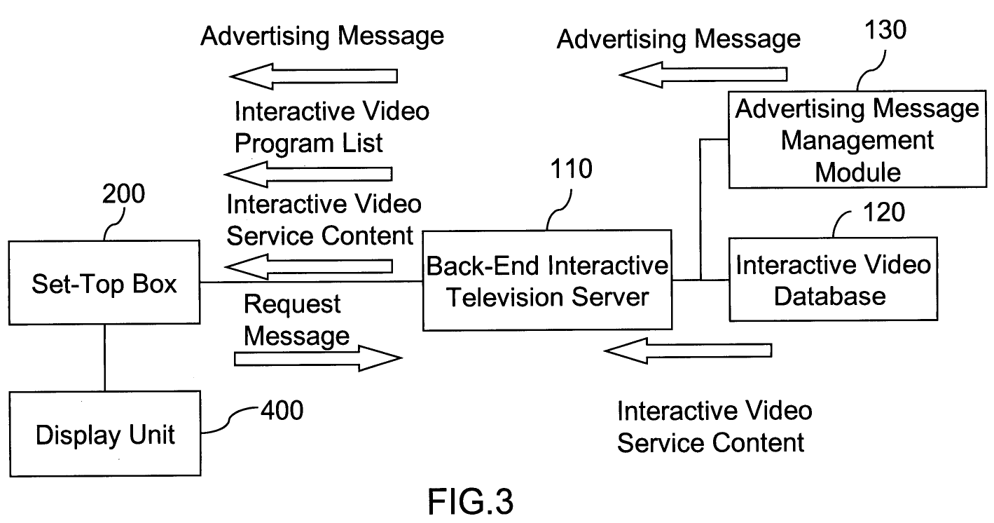

Referring to FIG. 3, the interactive video database 120 stores a plurality of interactive television service contents, and interactive video database 120 is connected to the back-end interactive television server 110. The back-end interactive television server 110 generates various interactive video program lists from the interactive video database 120 according to the different set-top box's request message. The set-top boxes show a plurality of selection items according to the interactive video program lists, and each selection item corresponds to different interactive video service contents in the interactive video database 120. When a user selects one of the items through the set-top box 200, the back-end interactive television server 110 retrieves the corresponding interactive video service content from the interactive video database 120 and transmits it to the set-top box 200.

Referring to FIG. 3 again, also shows the advertising message management module 130 is connected to the back-end interactive television server 110 for adding, editing, setup, managing and storing the advertising messages. The back-end interactive television server 110 retrieves one or more advertising messages based on specific rules or conditions and transmit them to the set-top box 200. Then the set-top box 200 generates display signals to a display unit 400, and the advertising messages are displayed on the display unit 400. The form of advertising messages can be a bar running on the lower part of the screen of the display unit 400, a pop-up window which covers part of the screen, a half transparent covered block or a traditional full screen image.

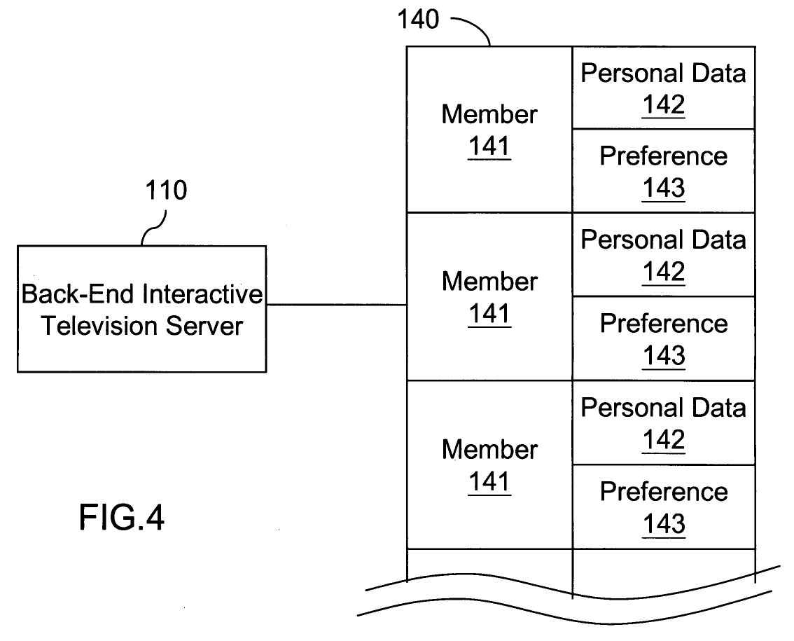

Referring to FIG. 4, the member database 140 is connected to the back-end interactive television server 110, wherein the member database 140 stores personal data 142 and preferences 143 of a plurality of members 141. The personal data of the members 141 includes gender, age, academic and the economic status and so on. The preferences 143 are member's related data other than the basic information, which is retrieved by other management system for the back-end interactive television server 110 to produce an interactive video program list which corresponds to the preferences.

Except using a one-way exhibition to deliver the advertising message, the advertising message can also be delivered by two-way communication, such as question asking, polls, message reminding, votes, prize draw or personal message management so after receiving the messages, a viewer can respond to the back-end television server 110 by the set-top box 200 and record the related information in the member database 140.

Additionally, except for the setup process, the preferences 143 and the personal data 142 of the members can also be updated by providing the advertising messages, an interactive television service, the participation of the activities of the user, or the poll.

Following paragraphs are the methods of the back-end interactive television server 110 of how to determine what kind of the advertising messages to be sent to the set-top boxes 200.

First, advertising messages are selected according to the interactive video service content. The interactive video service contents are classified based on the attributes at first, and then these classified rules for the interactive video service contents are stored in the back-end interactive television server 110. At the same time, the advertising messages are also classified according to the attributes, and then these classified rules for the advertising messages will be stored in the advertising message management module 140. When a set-top box 200 requests an interactive video service content through selecting a selection item of the interactive video program list, the back-end interactive television server 110 will retrieve one or more advertising messages according to the interactive video service content by using the advertising message classifying rules to determine which class of the advertising message is matched, and then send it with the interactive video service content to the set-top box 200 to be displayed in the display unit 400. Besides, the selection of the advertising messages also can be made according to the time to be broadcasted at. Same interactive video service contents may have different viewers at different time. Therefore, the most adequate advertising message can be provided by cross matching the viewers for the time and the interactive video service content.

Second, an advertising message is selected based on the interactive video program list. The interactive video program list is setup on the back-end interactive television server 110 in advance based on the demand of the user. At the time of setup, for this interactive video program list, a classifying rule for advertising message is built. When the back-end interactive television server 110 transmits the interactive video program list to the set-top box 200, the advertising message management module 140, at the same time retrieves the advertising message according to this classifying rule for advertising message and transmits it to the set-top box 200 randomly or in order to display the advertising messages and the interactive video program lists together in the display unit 400. After the user selects the interactive video service contents by the set-top box 200, the advertising messages are continuously displayed by the original interactive video program list or by a transformed mode which selects advertising message that according to the interactive video service content.

Third, an advertising message is selected according to the differences of the members 141 who log on the set-top box 200. There are two methods under this mode. The first method is producing the classifying rule for advertising messages based on the personal data, such as gender, age, and academic and economic status. Here, when a member 141 is logging in by the set-top box 200, this classifying rule for advertising messages is used to select an advertising message according to the personal data 142 and transmit it to the set-top box 200 for the display unit 400 to display with the interactive video program list and the interactive video service content so to improve the advertising effect. The second method is selecting the advertising messages based on the preference 143 of the member 141 in the member database 140, so when a member 141 logs in by the set-top box 200, the back-end interactive television server 110 directly retrieves the advertising messages according to the member demands from the advertising message management module 130.

Fourth, the classifying rule for advertising messages is generated according to the place where the set-top box 200 is, in which the advertising effect can be improved by selecting the most appropriate advertising message based on the differences of the place. When the set-top box 200 connects to the back-end interactive television server 110, the back-end interactive television server 110 can first determine where the set-top box 200 is (by the set-top box 200 generating an identified code transmitting to the back-end interactive television server 110 or by recording the related information when a set-top box 200 is installed) to retrieve the advertising message according to the place from the advertising message management module 130 so to improve the advertising effect on the specific place and the specific viewer group. In addition, one place can have more than one set-up boxes 200. For example, a household may have set-top boxes 200 in the living room, bed room and the dining room at the same time. Therefore, a place can be defined as a household so that all the set-top boxes are all in the same place, therefore the advertising messages which are provided to the household based on the setup can be delivered to all set-top boxes 200 regardless of the position of the set-top boxes 200. On the other hand, the living room, bed room and dining room can be set up as an independent place for receiving different advertising messages since different places of the houses may have different purposes or different demands for the advertisement. Moreover, regional demanding for local advertisements (ex: the advertisements for the shops in a neighborhood or a community) also can de divided by using a community or a building as a unit to provide corresponding advertising message. Under this method, each set-top box 200 can be set up as having different defined places at the same time. For example, the set-top box 200 in a master's bed room will be allowed to receive the advertising messages for adults since it has a defined place of master room; will be allowed to receive the advertising message about family matters since the room was inside the house and surely will be allowed to receive the advertising message related to the region where the house located.

The present TV advisements can not be broadcasted to the specific viewers. As a result, some advisements will be broadcasted to wrong people at the wrong time, which can not achieve the advertising effect the advisements should be or even lead to the disgusting of the viewer. The present invention can deliver appropriate advertisements based on the habit of the viewers so that the advertising effect can be optimized.

While the illustrative embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. An interactive television service system for providing personalized advertising message, which connects to at least one set-top box through a network, wherein the set-top box is provided to output an image signal to a display unit, the system comprises:
an back-end interactive television server, connecting to the set-top box through the network, to transmit one of a plurality of interactive video program lists and one of a plurality of interactive video service contents to the set-top box; and
an advertising message management module connected to the back-end interactive television server, for storing a plurality of advertising messages, wherein the back-end interactive television server retrieves at least one advertising message from the advertising message management module to the set-top box when the back-end interactive television server transmits the interactive video program list and the interactive video service content.

2. The system as claimed in claim 1, wherein the back-end interactive television server selects one of the advertising messages according to one of the interactive video program lists to the set-top box by mapping the interactive video program lists in the advertising message management module.

3. The system as claimed in claim 1, wherein the back-end interactive television server selects one of the advertising messages according to one the interactive video service contents to the set-top box by mapping the interactive video service contents in the advertising message management module.

4. The system as claimed in claim 1, further comprising a member database connected to the back-end interactive television server, which stores personal data and preferences of a plurality of members.

5. The system as claimed in claim 4, wherein the back-end interactive television server selects one of the advertising messages according to the interactive video service contents to the set-top box by mapping the personal data of the members in the advertising message management module.

6. The system as claimed in claim 4, wherein the back-end interactive television server selects one of the advertising messages according to the preferences of the members to the set-top box by mapping the preferences of the members in the advertising message management module.

7. The system as claimed in claim 4, wherein the personal data of the members includes gender, age, and academic and economic status.

8. The system as claimed in claim 4, wherein the advertising message management module includes functions of adding, editing, setup, managing and storing a plurality of advertising messages.

9. The system as claimed in claim 4, wherein the back-end interactive television server selects one of the advertising messages which according to the places of the set-top boxes to the set-top box by mapping the places of the set-top boxes in the advertising message management module.
